(19) United States
(12) Patent Application Publication
(10) Pub. No.: US 2012/0218978 A1
(43) Pub. Date: Aug. 30, 2012

(54) WIRELESS LAN SYSTEM

(75) Inventor: Takashi Ishidoshiro, Nagoya-shi (JP)

(73) Assignee: Buffalo Inc., Nagoya-shi (JP)

(21) Appl. No.: 13/286,482

(22) Filed: Nov. 1, 2011

(30) Foreign Application Priority Data
Nov. 1, 2010 (JP) 2010-245436

(51) Int. Cl. H04W 88/08

(52) U.S. Cl. 370/338

(57) ABSTRACT

A wireless LAN system comprises a wireless LAN access point for communicating wirelessly with a wireless LAN terminal, and a LED light bulb using a LED device as a light source. The wireless LAN access point is embedded in the LED light bulb.

### CROSS REFERENCE TO RELATED APPLICATION

This application is based upon and claims the benefit of priority from the prior Japanese Patent Application No. 2010-245436 filed on Nov. 1, 2010; all the contents of which are incorporated herein by reference.

### BACKGROUND OF THE INVENTION

1. Field of the Invention

This invention relates to a wireless LAN system for communicating wirelessly by using a wireless LAN.

2. Description of Related Art

In a wireless LAN system, a wireless LAN terminal and a wireless LAN access point communicates wirelessly with each other by using a wireless LAN. A LAN cable for communicating with an external network on an infrastructure side and a power cable for receiving power supply are connected to the wireless LAN access point. For this reason, the wireless LAN access point has problems that the appearance of a room interior is spoiled and that a possible location for installing the wireless LAN access point is limited.

In view of these problems, there has been proposed a wireless LAN system using a wireless LAN access point attached adjacent to a lighting fixture located on a ceiling of a room (see Patent Document 1: International Patent Application Publication No. WO2008/007514). In the wireless LAN system disclosed in Patent Document 1, a wireless LAN access point attached adjacent to a lighting fixture communicates with an external network on an infrastructure side byway of power line communication (PLC) using a power line through which the lighting fixture receives power supply.

In the wireless LAN system disclosed in Patent Document 1, however, the lighting fixture and the wireless LAN access point are provided separately. Accordingly, a user has to install both of the lighting fixture and the wireless LAN access point, and hence there is room for improvement in enhancing usability.

### SUMMARY OF THE INVENTION

It is an object of this invention to provide a wireless LAN system having enhanced usability.

In order to solve the problems described above, the present invention has the following feature. According to one of the features of this invention, there is provided a wireless LAN system comprising: a wireless LAN access point (wireless LAN access point AP) for communicating wirelessly with a wireless LAN terminal (wireless LAN terminal 200); and a LED light bulb (LED light bulb 100) using a LED device (LED device 150) as a light source, wherein the wireless LAN access point is embedded in the LED light bulb.

According to this feature, the wireless LAN access point is embedded in the LED light bulb by utilizing the characteristics of the LED light bulb of the low calorific power and the long product life. In this way, it is possible to establish a wireless LAN environment just by plugging the LED light bulb into a socket and to enhance usability.

According to another feature of this invention, the LED light bulb irradiates light in a light irradiation pattern at a limited light irradiation angle, and the wireless LAN access point emits a radio wave in a radio wave emission pattern matching entirely or almost entirely with the light irradiation pattern.

According to this feature, the wireless LAN access point emits the radio waves in the radio wave emission pattern matching entirely or almost entirely with the light irradiation pattern at the limited light irradiation angle. This lowers the possibility of an interference with radio waves from another wireless LAN access point. Here, the LED light bulb and the wireless LAN access point are integrated as described in the previous feature. Hence, the light irradiation pattern can be matched entirely or almost entirely with the radio wave emission pattern in advance. Moreover, a user who owns a wireless LAN terminal can visually check a communicatable range of the wireless LAN access point as being a range illuminated by the light from the LED light bulb.

According to another feature of this invention, the wireless LAN access point comprises a directional antenna (directional antenna 170).

According to this feature, using the directional antenna enables emission of the radio waves in the radio wave emission pattern matching entirely or almost entirely with the light irradiation pattern.

According to another feature of this invention, the LED light bulb comprises a reflector, and the reflector houses the LED device and the directional antenna.

According to another feature of this invention, the wireless LAN access point comprises an antenna (nondirectional antenna 170′), and the LED light bulb comprises a radio wave absorber (radio wave absorber 181) for absorbing a radio wave emitted from the antenna in a direction different from a specific direction (direction D1).

According to this feature, the light irradiation pattern from the LED light bulb can be entirely or almost entirely matched with the radio wave emission pattern from the wireless LAN access point even when the antenna does not have directivity.

According to another feature of this invention, the LED light bulb comprises a reflector, the reflector houses the LED device and the antenna, and the radio wave absorber covers an outside of the reflector.

According to another feature of this invention, the LED light bulb comprises: a LED drive circuit (LED drive circuit 140) for driving the LED device; a power source circuit (power source circuit 130) for supplying power at least to the LED drive circuit; and an enclosure (enclosure 110) which houses at least the LED device, the LED drive circuit, and the power source circuit. The wireless LAN access point comprises: an antenna housed in the enclosure; and a wireless LAN communication circuit (wireless LAN communication circuit 160) housed in the enclosure, connected to the antenna, and receiving power supply from the power source circuit.

According to this feature, the wireless LAN access point is provided in the LED light bulb and the single power source circuit is used in common as the power source circuit for supplying the power to the LED drive circuit and as the power source circuit for supplying the power to the wireless LAN communication circuit. In this way, it is possible to reduce the number of components and manufacturing costs.

According to another feature of this invention, the LED light bulb is plugged into a socket connected to a power line for supplying a power, and the wireless LAN access point embedded in the LED light bulb communicates with a network by way of power line communication (PLC) using the power line.

According to another feature of this invention, the LED light bulb is provided in front of a showpiece, and the wireless LAN access point embedded in the LED light bulb transmits information on the showpiece.

### BRIEF DESCRIPTION OF THE DRAWINGS

FIG. 1 shows an overall schematic configuration of a wireless LAN system according to an embodiment of this invention.

FIG. 2 is a block diagram showing a block configuration of a LED light bulb according to the embodiment of this invention.

FIG. 3 is a schematic layout diagram for explaining a layout of blocks constituting the LED light bulb according to the embodiment of this invention.

FIG. 4 shows an overall schematic configuration showing an application example of the wireless LAN system according to the embodiment of this invention.

FIG. 5 is a schematic cross-sectional view showing a configuration around a reflector according to another embodiment.

### DESCRIPTION OF THE EMBODIMENTS

Embodiment of this invention will be described below with reference to the accompanying drawings and in the order of (1) Configuration of Wireless LAN System, (2) Configuration of LED Light Bulb, (3) Application Example, (4) Effect of Embodiment, (5) Modified Example, and (6) Other Embodiments. In all the drawings of the following embodiments, the same or similar components are labeled with the same or similar reference numerals.

### (1) Configuration of Wireless LAN System

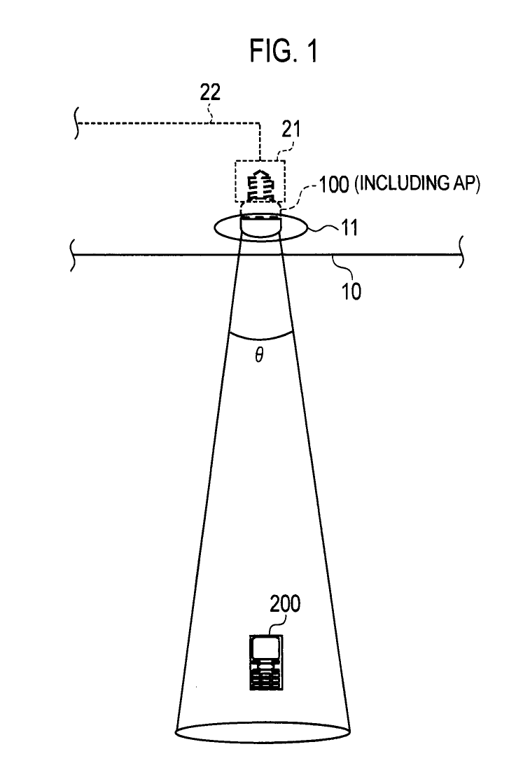

FIG. 1 shows an overall schematic configuration of a wireless LAN system according to this embodiment.

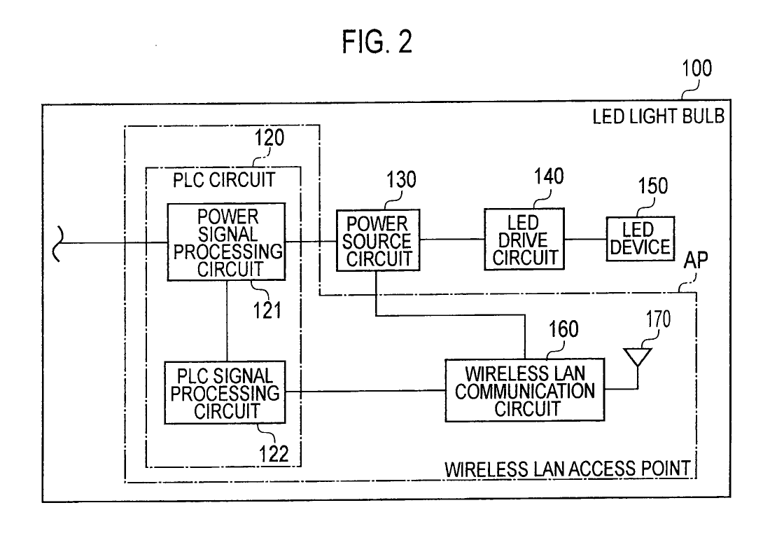

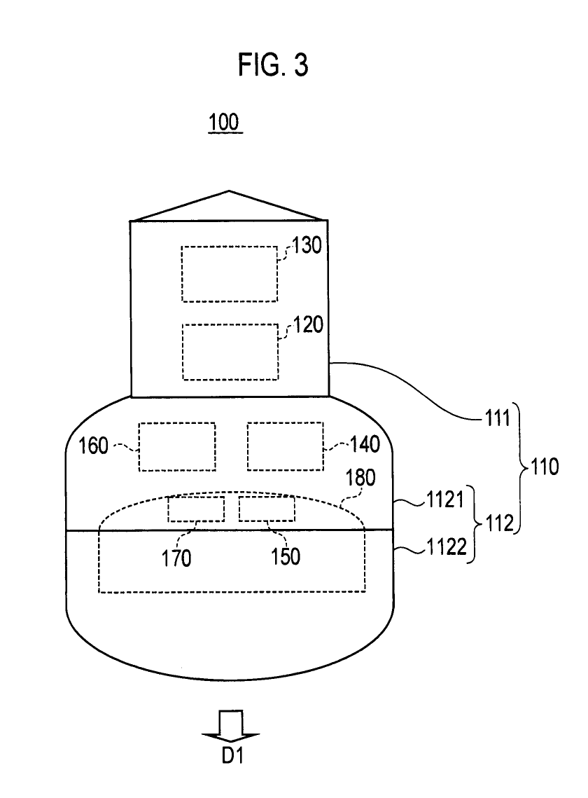

As shown in FIG. 1, the wireless LAN system according to this embodiment is a wireless LAN system in which a wireless LAN access point AP for communicating wirelessly with a wireless LAN terminal 200 is provided in a lighting fixture. The lighting fixture includes a LED light bulb 100 which uses a LED device 150 (see FIG. 2 and FIG. 3) as a light source. Meanwhile, the wireless LAN access point AP is embedded in the LED light bulb 100.

The wireless LAN terminal 200 is a tablet device, a notebook PC, or a card terminal having a wireless LAN communication function. Here, the wireless LAN communication means the communication in compliance with the IEEE82.11 standards, for example.

The LED light bulb 100 is plugged into a socket 21 provided on an opening portion 11 in a ceiling 10. The socket 21 is connected to a power line 22 provided in the ceiling 10 and receives power supply via the power source line 22. In this embodiment, the wireless LAN access point AP embedded in the LED light bulb 100 communicates with an external network on an infrastructure side by way of power line communication (PLC) using the power line 22.

The LED light bulb 100 has optical directivity and emits light in a light irradiation pattern at a limited light irradiation angle. To be more precise, the LED light bulb 100 is formed as a spot light. A light irradiation angle θ of the LED light bulb 100 is smaller than 90°, for example. Here, the light irradiation angle θ means a spread angle of the light when the light from the LED bulb 100 is distributed at uniform luminous intensity. Nevertheless, when the luminous intensity is very low on the outside, the spread angle of the light may be defined as the light irradiation angle θ after portions with very low luminous intensity are removed.

The wireless LAN access point AP embedded in the LED light bulb 100 has radio wave directivity, and is configured to emit radio waves in a radio wave emission pattern matching entirely or almost entirely with the light irradiation pattern of the LED light bulb 100. The expression “almost entirely” means that the radio emission pattern is within a range of the light irradiation angle θ±30°, for example.

### (2) Configuration of LED Light Bulb

Next, the configuration of the LED light bulb 100 according to this embodiment will be described below in the order of (2. 1) Block Configuration and (2. 2) Layout.

### (2. 1) Block Configuration

FIG. 2 is a block diagram showing a block configuration of the LED light bulb 100.

As shown in FIG. 2, the LED light bulb 100 includes a power signal processing circuit 121 connected to the power line 22 via the socket 21 and a base 111 (see FIG. 3), a PLC signal processing circuit 122 and a power source circuit 130 which are connected to the power signal processing circuit 121, a wireless LAN communication circuit 160 connected to the PLC signal processing circuit 122 and to the power source circuit 130, a directional antenna 170 connected to the wireless LAN communication circuit 160, a LED drive circuit 140 connected to the power source circuit 130, and a LED device 150 connected to the LED drive circuit 140.

Each of the power signal processing circuit 121, the PLC signal processing circuit 122, the power source circuit 130, and the wireless LAN communication circuit 160 is a semiconductor integrated circuit (i.e. an IC), for example.

The power signal processing circuit 121 and the PLC signal processing circuit 122 collectively constitute a PLC circuit 120 which executes the power line communication (PLC). The PLC circuit 120, the wireless LAN communication circuit 160, and the antenna 170 collectively constitute the wireless LAN access point AP which executes wireless LAN communication with the wireless LAN terminal 200.

The power signal processing circuit 121 extracts a PLC signal (a downlink signal) which is superposed on a power signal from the power line 22, and outputs the PLC signal to the PLC signal processing circuit 122. The power signal processing circuit 121 superposes a PLC signal (an uplink signal) from the PLC signal processing circuit 122 on the power signal.

The power source circuit 130 generates electric power by using the power signal that passes through the PLC signal processing circuit 122 and outputs the electric power to the LED drive circuit 140 and to the wireless LAN communication circuit 160. The LED drive circuit 140 is operated by the electric power supplied from the power source circuit 130 so as to drive the LED device 150.

The PLC signal processing circuit 122 processes the PLC signal (the downlink signal) from the power signal processing circuit 121 and outputs a processing result to the wireless LAN communication circuit 160. Moreover, the PLC signal processing circuit 122 processes a signal (an uplink signal) from the wireless LAN communication circuit 160 and outputs a processing result to the power signal processing circuit 121.

The wireless LAN communication circuit 160 transmits and receives wireless LAN signals via the antenna 170. To be more precise, the wireless LAN communication circuit 160 converts the signal (the downlink signal) from the PLC signal processing circuit 122 into a wireless LAN signal and transmits the wireless LAN signal. Meanwhile, the wireless LAN communication circuit 160 processes a wireless LAN signal (an uplink signal) received via the antennal 170 and outputs the processed signal to the PLC signal processing unit 122.

The directional antenna 170 is a dielectric antenna or a fractal antenna, for example, and is formed to have a radio wave emission angle matching with the light irradiation angle. Meanwhile, the wireless LAN communication circuit 160 is preset to such transmission power as to match the radio wave emission pattern with the light irradiation pattern.

### (2. 2) Layout

FIG. 3 is a schematic layout diagram for explaining a layout of blocks constituting the LED light bulb 100.

As shown in FIG. 3, all the blocks described by using FIG. 2 are housed in an enclosure 110 of the LED light bulb 100. The enclosure 110 includes the base 111 to be plugged into the socket 21, a trumpet shaped cover 1121 spreading from an end of the base 111 in a trumpet shape, and a light transmissive cover 1122 attached to an opening portion of the trumpet shaped cover 1121. The trumpet shaped cover 1121 and the light transmissive cover 1122 collectively constitute a spherical cover 112.

The PLC circuit 120 and the power source circuit 130 are located inside the base 111. The PLC circuit 120 is located closer to an irradiating direction D1 than the power source circuit 130, but these circuits may be located the other way round.

The LED drive circuit 140 and the wireless LAN communication circuit 160 are located inside the trumpet shaped cover 1121. Meanwhile, a reflector 180 for irradiating the light from the LED device 150 toward the irradiating direction D1 is disposed inside the spherical cover 112 in a position closer to the irradiating direction D1 than the LED drive circuit 140 and the wireless LAN communication circuit 160. The reflector 180 is formed into a semispherical shape so as to house the LED device 150 and the directional antenna 170. Here, the directional antenna 170 may be located beside the reflector 180 or behind the reflector 180 instead.

### (3) Application Example

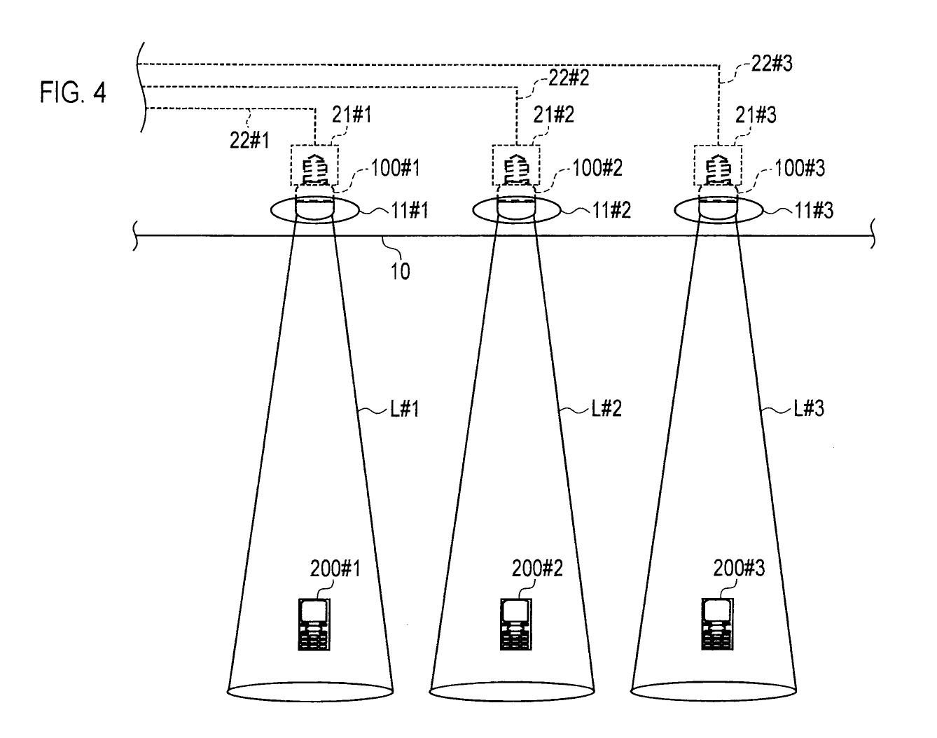

FIG. 4 shows an overall schematic configuration showing an application example of the wireless LAN system according to the embodiment described above. This application example assumes the case of providing a spot light for each of showpieces as in a museum or in a gallery, for example.

As shown in FIG. 4, in this application example, the LED light bulbs 100 (100#1 to 100#3) serving as spot lights are located close to one another. The wireless LAN terminal 200 receives a radio wave from the wireless LAN access point AP embedded in any of the LED light bulbs 100 in a position in front of one of the showpieces illuminated by the corresponding LED light bulb 100. Hence the wireless LAN terminal 200 starts wireless LAN communication with the wireless LAN access point AP. The wireless LAN access point AP stores in advance information on the corresponding showpiece and transmits the information to the wireless LAN terminal 200. Hence the wireless LAN terminal 200 receives and displays the information on the showpiece.

### (4) Effect of Embodiment

As described above, according to this embodiment, the wireless LAN access point AP is embedded in the LED light bulb 100 by utilizing the characteristics of the LED light bulb 100 of low calorific power and long product life. In this way, it is possible to establish a wireless LAN environment just by plugging the LED light bulb 100 into the socket 21 and to enhance usability.

Moreover, according to this embodiment, the wireless LAN access point AP emits the radio waves in the radio wave emission pattern matching entirely or almost entirely with the light irradiation pattern at the limited light irradiation angle. This can lower the possibility of an interference with radio waves from another wireless LAN access point. Here, the LED light bulb 100 and the wireless LAN access point AP are integrated. Hence the light irradiation pattern can be matched entirely or almost entirely with the radio wave emission pattern in advance. Moreover, a user who owns the wireless LAN terminal 200 can visually check a communicatable range of the wireless LAN access point AP as being a range illuminated by the light from the lighting fixture (the LED light bulb 100).

Furthermore, in this embodiment, the wireless LAN access point AP is provided in the LED light bulb 100 and the single power source circuit is used in common as the power source circuit 130 for supplying the power to the LED drive circuit 140 and as the power source circuit 130 for supplying the power to the wireless LAN communication circuit 160. In this way, it is possible to reduce the number of components and manufacturing costs.

### (5) Modified Example

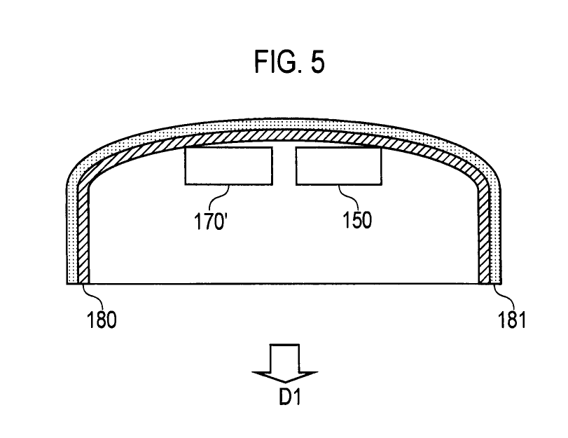

FIG. 5 is a schematic cross-sectional view showing a configuration around the reflector 18. This modified example uses a nondirectional antenna 170′ instead of the directional antenna 170 as in the above-described embodiment.

As shown in FIG. 5, this modified example includes a radio wave absorber 181 for covering the outside of the reflector 180 and absorbing radio waves emitted from the nondirectional antenna 170′ to directions other than the direction D1.

According to this structure, the light from the LED device 150 is irradiated toward the irradiating direction D1 by way of reflection with the reflector 180. The radio waves from the nondirectional antenna 170′ are transmitted through the reflector 180 but are absorbed by the radio wave absorber 181. As a result, the radio waves from the nondirectional antenna 170′ are eliminated except the portion oriented to the irradiating direction D1.

As described above, according to this modified example, the light irradiation pattern can be matched entirely or almost entirely with the radio wave emission pattern even in the case of using the nondirectional antenna 170′.

Here, the radio wave absorber 181 has the shape having at least an opening portion in the irradiating direction D1 (a specific direction) and is therefore formed into the semispherical shape in this modified example in conformity to the shape of the reflector 180. Instead, the radio wave absorber 181 may be formed into any other shapes such as a cylindrical shape.

### (6) Other Embodiments

As described above, the details of this invention have been disclosed by using the embodiment of this invention. However, it should not be understood that the description and drawings which constitute part of this disclosure limit this invention. From this disclosure, various alternative embodiments, examples, and operation techniques will be easily found by those skilled in the art.

For example, in the above-described embodiment, the wireless LAN communication circuit 160 is preset to such transmission power as to match the radio wave emission pattern with the light irradiation pattern. Instead, a radio wave absorbing sheet may be provided on a bottom surface in the case where the communicatable range is increased by reflection of the radio waves on the bottom surface.

As described above, this invention naturally includes various embodiments which are not described herein.

What is claimed is:

1. A wireless LAN system comprising:
a wireless LAN access point for communicating wirelessly with a wireless LAN terminal; and
a LED light bulb using a LED device as a light source, wherein
the wireless LAN access point is embedded in the LED light bulb.

2. The wireless LAN system according to claim 1, wherein
the LED light bulb irradiates light in a light irradiation pattern at a limited light irradiation angle, and
the wireless LAN access point emits a radio wave in a radio wave emission pattern matching entirely or almost entirely with the light irradiation pattern.

3. The wireless LAN system according to claim 2, wherein
the wireless LAN access point comprises a directional antenna.

4. The wireless LAN system according to claim 3, wherein
the LED light bulb comprises a reflector, and
the reflector houses the LED device and the directional antenna.

5. The wireless LAN system according to claim 2, wherein
the wireless LAN access point comprises an antenna, and
the LED light bulb comprises a radio wave absorber for absorbing a radio wave emitted from the antenna in a direction different from a specific direction.

6. The wireless LAN system according to claim 5, wherein
the LED light bulb comprises a reflector,
the reflector houses the LED device and the antenna, and
the radio wave absorber covers an outside of the reflector.

7. The wireless LAN system according to claim 1, wherein
the LED light bulb comprises:
a LED drive circuit for driving the LED device;
a power source circuit for supplying power at least to the LED drive circuit; and
an enclosure which houses at least the LED device, the LED drive circuit, and the power source circuit.

8. The wireless LAN system according to claim 7, wherein
the wireless LAN access point comprises:
an antenna housed in the enclosure; and
a wireless LAN communication circuit housed in the enclosure, connected to the antenna, and receiving power supply from the power source circuit.

9. The wireless LAN system according to claim 1, wherein
the LED light bulb is plugged into a socket connected to a power line for supplying a power, and
the wireless LAN access point embedded in the LED light bulb communicates with a network by way of power line communication (PLC) using the power line.

10. The wireless LAN system according to claim 1, wherein
the LED light bulb is provided in front of a showpiece, and
the wireless LAN access point embedded in the LED light bulb transmits information on the showpiece.
